(19) United States
(12) Patent Application Publication
(10) Pub. No.: US 2004/0104900 A1
(43) Pub. Date: Jun. 3, 2004

(54) Touch panel with liquid crystal display device

(75) Inventors: Yong Ik Bang, Taegu-kwangyokshi (KR); Hee Jeong Park, Kyonggi-do (KR)

Correspondence Address: MORGAN LEWIS & BOCKIUS LLP, 1111 PENNSYLVANIA AVENUE NW, WASHINGTON, DC, 20004, US

(73) Assignee: LG.PHILIPS LCD CO., LTD.

(21) Appl. No.: 10/704,871

(22) Filed: Nov. 12, 2003

(30) Foreign Application Priority Data
Nov. 15, 2002 (KR) P 2002-71188

(51) Int. Cl. G09G 5/00

(52) U.S. Cl. 345/173

(57) ABSTRACT

A touch panel integrated with an LCD device includes a lower polarizing plate, an LCD panel having a lower substrate on the lower polarizing plate, an upper substrate on the lower substrate, and a liquid crystal layer between the upper and lower substrates, an upper polarizing plate on the upper substrate having a planar surface and a touch panel bonded directly to the planar surface of the upper polarizing plate.

This application claims the benefit of Korean Application No. P2002-71188 filed on Nov. 15, 2002, which is hereby incorporated by reference.

### BACKGROUND OF THE INVENTION

1. Field of the Invention

The present invention relates to a touch panel, and more particularly, a touch panel with an LCD device for obtaining comfortable writing sensation and endurance by improving an upper polarizing plate of an LCD panel integrated with a touch panel.

2. Discussion of the Related Art

In personal information processors, such as a personal computer or a mobile transmission device, various input devices like a keyboard, mouse and digitizer have been generally used to input text and graphics. As the personal computer is being developed for use in various fields, it has been required to use a touch panel instead of a keyboard and mouse due to the need for both mobility and simplicity. For example, a user can input information, such as letters, on the touch panel while carrying the touch panel. Recently, the touch panel has developed from a device merely satisfying a general input functions to a highly capable device having high reliability and endurance.

A touch panel on a display surface is capable of sensing when and where a user touches a display surface. Touch panels are classified into a resistive type, a capacitive type, a supersonic wave type, an infrared type, and electromagnetic type. In the resistive type touch panel, two resistive sheets are positioned opposite to each other at a predetermined interval by dot spacers. Thus, when a user touches a portion of the touch panel on the display surface, the two resistive sheets are in contact to each other at the touched portion. The respective type touch panels have different resolution, design and process technology characteristics, so that the type of the touch panel is selected according to a purpose of a display device using the touch panel in due consideration of economical efficiency and endurance as well as electro-optics, electrical, mechanical, and input characteristics.

Among the various type touch panels, the resistive type touch panel integrated with a liquid crystal display (LCD) device is widely used for an input device of an electronic notebook, a PDA, and a mobile PC because the resistive type touch panel has the advantages of a thin profile, small size and low power consumption. In the resistive type touch panel, the location of a touching point is detected according to a matrix method or an analog method. Upper and lower substrates for the resistive type touch panel are formed of either a film substrate with a thickness of 0.1 mm to 0.2 mm, a glass substrate with a thickness of 0.2 mm to 2 mm, or a plastic substrate with a thickness of 1 mm to 2 mm. Lower and upper electrodes are respectively formed on the lower and upper substrates. Accordingly, when a surface of an upper substrate having the upper electrode is touched at a point using input instrument, such as a finger, a pen or stylus, the upper electrode on the upper substrate is electrically connected to the lower electrode on a lower substrate. A control unit reads a voltage value based on a resistance value of the touching point to detect the coordinates of the touching point.

Hereinafter, an analog resistive type touch panel according to the related art will be described with reference to FIGS. 1 and 2. FIG. 1 is a plan view illustrating a related art touch panel. FIG. 2 is a cross-sectional view taken along line I-I′ of FIG. 1. As shown in FIG. 1 and FIG. 2, the touch panel includes a viewing area V/A 10 corresponding to the display surface of the LCD device, and a dead space region 15 surrounding the viewing area V/A 10 at the periphery of the viewing area V/A 10. The upper and lower substrates 1 and 2 are formed of Polyethylene Terephtalate (PET) films and are bonded to each other in the dead space region 15 by an insulating adhesive 8 at a predetermined interval. Rectangular transparent electrodes 3 and 4 are respectively formed on the upper and lower substrates 1 and 2 in correspondence with the viewing area V/A 10. Also, a signal line 7 is connected to one of the transparent electrodes 3 and 4 in the dead space 15 for applying a voltage to the transparent electrodes 3 and 4, and for reading a voltage value variable by a location of a touching point. A plurality of dot spacers 6 are formed on the lower transparent electrode 4 at intervals to prevent the transparent electrodes 3 and 4 from being in contact with each other except for an application of light pressure. The plurality of dot spacers 6 are formed of an insulating synthetic resin material, such as epoxy or acrylic resin.

When a portion of the upper substrate 1 is touched with a pen or a finger at a predetermined pressure, the upper and lower transparent electrodes 3 and 4 come into contact with each other at the touched portion. As a result, a voltage value based upon a resistance value corresponding to the touching point is output by the signal line 7. However, if an undesired portion of the upper substrate 1 is also lightly touched with the hand, the position of the touch portion may not be accurately recognized as the touched input location.

FIG. 3 is a cross-sectional view illustrating a general touch panel integrated with an LCD device. Referring to FIG. 3, the general touch panel integrated with the LCD device includes a lower polarizing plate 50, an LCD panel 40, an upper polarizing plate 20, and a touch panel 30. The LCD panel 40 has a lower substrate 41 on the lower polarizing plate 50, and an upper substrate 42 on the lower substrate 41. The upper polarizing plate 20 is formed on the upper substrate 42. The touch panel 30 includes a lower substrate 31 on the upper polarizing plate 20, and an, upper substrate 32 on the lower substrate 31. Also, a case top 70 is formed on an upper side of the touch panel 30 and at a lateral side of the entire structure. The upper substrate 42 and the lower substrate 41 of the LCD panel 40 respectively include a color filter array (not shown) and a thin film transistor array (not shown). A liquid crystal layer (not shown) is positioned between the two substrates 42 and 41. As explained with reference to FIG. 2, the transparent electrode (not shown), the dot spacers (not shown) and the insulating adhesive (not shown) are formed between the upper and lower substrates 31 and 32 of the touch panel 30 shown in FIG. 3.

A method for manufacturing the touch panel integrated with the LCD device of FIG. 3 will be described in reference to FIG. 4. FIG. 4 is a plan view illustrating a bonding method of a touch panel and a polarizing plate in the process for manufacturing a touch panel with an LCD device according to the related art. As shown in FIG. 4, the completed touch panel 30 and the upper polarizing plate 20 are cut to a size corresponding to the size of the touch panel 30 and are then bonded to each other in a laminating device to thereby form the touch panel integrated with the film type polarizing plate 20+30. The upper and lower substrates 42 and 41 of the LCD device, shown in FIG. 3, are also bonded to each other. Then, the lower polarizing plate 50, shown in FIG. 3, is adhered to the lower surface of the upper and lower substrates 42 and 41 bonded to each other. Subsequently, the touch panel integrated with the film type polarizing plate 20+30 is adhered to an upper surface of the LCD panel 40 having the lower polarizing plate 50. In the alternative, the upper polarizing plate 20 is first adhered to the upper surface of the LCD panel 40, and then the completed touch panel 30 is laminated onto the upper polarizing plate 20.

FIG. 5 is a cross-sectional view illustrating an upper polarizing plate of an LCD panel according to the related art. As shown in FIG. 5, an optical layer 22 is formed of polyvinyl alcohol (PVA), a first passivation layer 21 is formed underneath the optical layer 22, and a second passivation layer 23 is formed above the optical layer 22. The first and second passivation layers 21 and 23 are formed of Tri-Acetyl-Cellulose. Then, a hard-coating layer 24 is formed on the second passivation layer 23. Subsequently, an anti-glare process is performed to the hard coating layer 24 to prevent a surface of the upper polarizing plate from being scratched. The anti-glare process is performed by spraying particles onto the hard coating layer 24, or by forming an additional anti-glare layer having a plurality of embossed patterns.

FIG. 6 is a cross-sectional view illustrating a bonding method of a touch panel and an upper polarizing plate in a touch panel with an LCD device having the upper polarizing plate 20 of FIG. 5. Referring to FIG. 6, the upper polarizing plate 20 is formed by sequentially depositing a first passivation layer 21, an optical layer 22, a second passivation layer 23, and then a hard coating layer 24. The upper and lower substrates 32 and 31 of the touch panel 30 are bonded to each other by an adhesive 33. The bonded upper and lower substrates 32 and 31 are then bonded onto the hard coating layer 24, which is the uppermost layer of the upper polarizing plate 20.

As mentioned above, the touch panel integrated with the LCD device according to the related art, which includes the touch panel bonded to the polarizing plate, has the following disadvantages. In the touch panel integrated with the LCD device according to the related art, a hard coating layer is formed as the uppermost layer of the upper polarizing plate of the LCD panel that adheres to the lower surface of the touch panel. The hard coating layer is for obtaining an Anti-Glare effect and preventing the surface of the upper polarizing plate from being scratched. The hard coating layer is formed with a method including spraying particles or forming an anti-glare layer having a plurality patterns embossed thereon. However, writing on such a touch panel integrated on an LCD panel can be difficult because the touch points of a stylus (or finger) may not be easily tracked unless the user presses down hard throughout entire stroke of a stylus while writing. A user tires from having to press down hard while writing all the time. Further, the user and wears out the touch panel more quickly by pressing down hard on the touch panel.

### SUMMARY OF THE INVENTION

Accordingly, the present invention is directed to a touch panel integrated with an LCD device that substantially obviates one or more of the problems due to limitations and disadvantages of the related art.

An object of the present invention is to provide a touch panel integrated with an LCD device such that a user can write more comfortably.

Another object of the present invention is to increase life span of a touch panel by decreasing the need for a user to press down hard.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a touch panel integrated with an LCD device includes a lower polarizing plate, an LCD panel having a lower substrate on the lower polarizing plate, an upper substrate on the lower substrate, and a liquid crystal layer between the upper and lower substrates, an upper polarizing plate on the upper substrate having a planar surface and a touch panel bonded directly to the planar surface of the upper polarizing plate.

In another aspect, a touch panel integrated with an LCD device includes an LCD panel having a polarizing plate including first passivation layer, an optical layer on the first passivation layer, and a second passivation layer on the optical layer; and a touch panel bonded directly to the second passivation layer of the polarizing plate.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention.

FIG. 1 is a plan view schematically illustrating a related art touch panel.

FIG. 2 is a cross-sectional view taken along line I-I of FIG. 1.

FIG. 3 is a cross-sectional view illustrating a touch panel integrated with an LCD device according to the related art.

FIG. 4 is a plan view illustrating a bonding method of a touch panel and a polarizing plate in a process for manufacturing a touch panel integrated with an LCD device according to the related art.

FIG. 5 is a cross-sectional view illustrating an upper polarizing plate of an LCD panel according to the related art.

FIG. 6 is a cross-sectional view illustrating a bonding method of a touch panel and an upper polarizing plate in a touch panel integrated with an LCD device having an upper polarizing plate according to the related art.

FIG. 7 is a cross-sectional view illustrating a bonding method of a touch panel and an upper polarizing plate in a touch panel integrated with an LCD device according to an embodiment of the present invention.

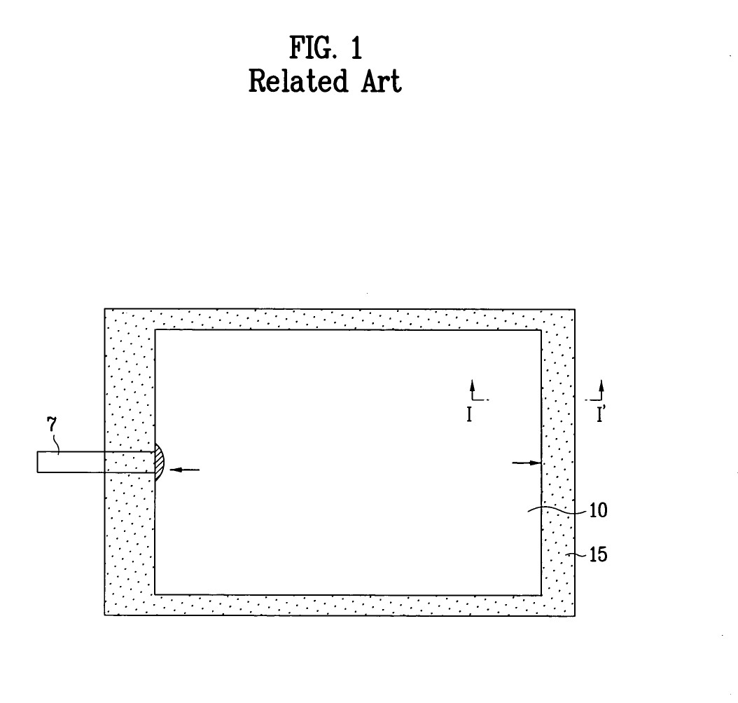

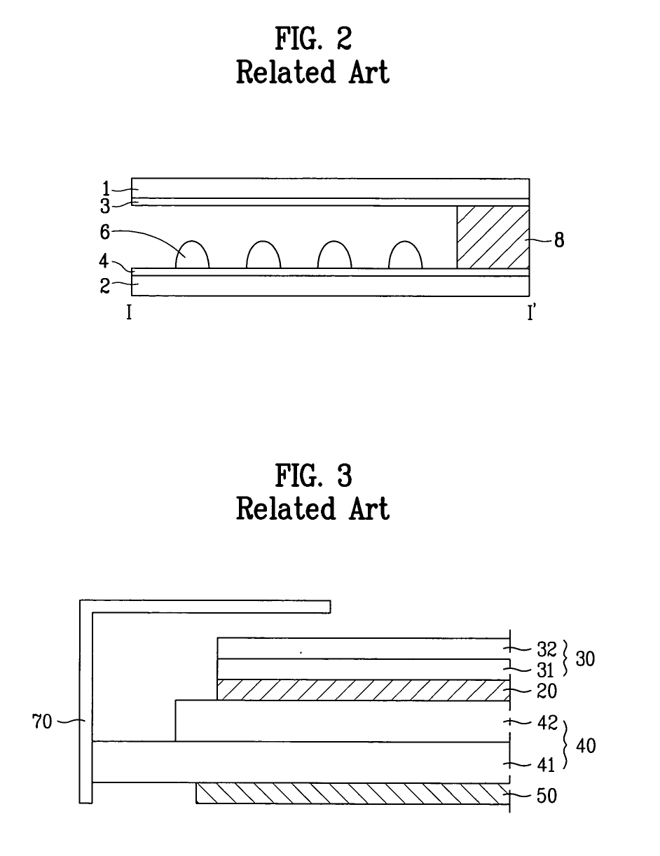

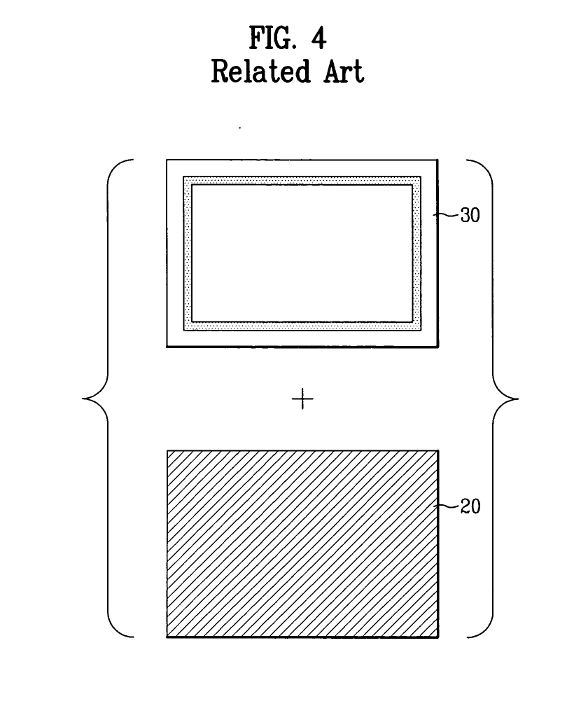

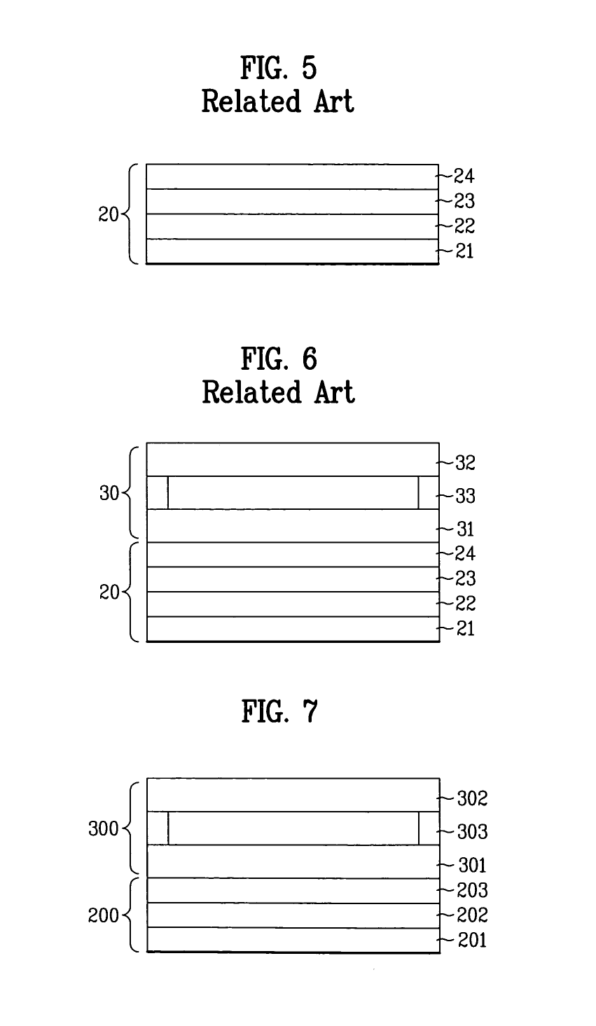

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts. The present inventors have discovered that the hard coating layer formed by spraying particles or forming an anti-glare layer having a plurality of patterns embossed thereon increases the need for users to have to press down harder a touch panel. More particularly, the anti-glare layer interferes with the detection of the touch points for a stylus (or finger) as it moves across the touch panel. Hereinafter, a touch panel integrated with an LCD device according to the preferred embodiments of the present invention will be described with reference to the accompanying drawings.

FIG. 7 is a cross-sectional view illustrating a bonding method of a touch panel and an upper polarizing plate in a touch panel integrated with an LCD device according to an embodiment of the present invention in which an upper surface of the upper polarizing plate 200 is adhered directly to a lower surface of the touch panel 300. The upper polarizing plate 200 includes a passivation layer 201, an optical layer 202 on the passivation layer 201, and another passivation layer 203 on the optical layer 202. The passivation layers 201 and 203 are formed, for example, of Tri-Acetyl-Cellulose (TAC) films. The optical layer 202 is formed of a polyvinyl alcohol (PVA) film, for example. The PVA film is formed in an adhesive alignment method with a bicolor pigment, such as a bicolor dye or an iodine material. The uppermost film of the upper polarizing plate 200 is the passivation layer 203, which is for protecting an upper surface of the optical layer 202 that polarizes light. An anti-glare or/and hard-coating process is/are not performed to an upper surface of the passivation layer 203 so that the passivation layer 203 has a planar surface. Thus, surfaces of the second passivation layer and the touch panel along where the touch panel bonds directly to the second passivation layer are planar.

The touch panel 300 includes a lower substrate 301, an upper substrate 302, and an adhesive layer 303 for bonding the lower and upper substrates 301 and 302 to each other. Accordingly, when bonding the touch panel 300 directly to the upper polarizing plate 200, the lower surface of the lower substrate 301 of the touch panel 300 is adhered to the upper surface of the passivation layer 203, which is the uppermost layer of the upper polarizing plate 200. Although not shown, the LCD device integrated with the touch panel 300 includes an LCD panel having a lower substrate, an upper substrate, and a liquid crystal layer between the lower and upper substrates, and lower and upper polarizing plates respectively formed on and underneath the LCD panel.

The touch panel 300 includes an upper substrate 302, a lower substrate 301 that is opposite to the upper substrate 302, and a double-sided adhesive 303 for bonding the upper substrate 302 to the lower substrate 301 about the periphery of the substrates. Various electrode patterns (not shown) are formed on the opposing surfaces of the upper and lower substrates 302 and 301 for detecting the location of a touch point. The upper and lower substrates 302 and 301 are formed of transparent Polyethylene Terephtalate (PET) films, for example.

In the case of a resistive type touch panel, transparent electrodes (not shown), such as Indium-Tin-Oxide (ITO), are formed on the opposing surfaces of the upper and lower substrates 302 and 301 that face each other. Further, metal electrodes (not shown) are respectively formed adjacent the periphery of the upper and lower transparent electrodes. Also, a line connected to the metal electrodes is connected to an external power source through a Flexible Printed Cable FPC (not shown) connected to one of the upper and lower substrates 302 and 301. The double-sided adhesive layer 303 is initially deposited on either one of the upper and lower substrates 302 and 301 at the periphery of the upper and lower substrates 302 and 301 to surround at least portions of a viewing area. Also, a plurality of dot spacers (not shown) are formed at fixed intervals in the viewing area between the upper and lower substrates 302 and 301 to maintain a predetermined gap between the upper and lower substrates 302 and 301.

For the aforementioned touch panel 300, the upper polarizing plate 200 is formed by sequentially depositing the first passivation layer 201, the optical layer 202 and then the second passivation layer 203 having a planar upper surface. A hard coating layer is not formed on the planar upper surface of the second passivation layer 203. Then a laminating process is performed to directly bond the touch panel 300 to the upper polarizing plate 200 having the passivation layer 201, the optical layer 202 and the second passivation layer 203, thereby completing the touch panel 300 integrated with the polarizing plate 200. During the laminating or bonding process, an adhesive may be formed on the lower surface of the lower substrate 301 of the touch panel 300 and/or on the upper surface of the passivation layer 203 of the upper polarizing plate 200, either entirely or partially about the periphery.

When bonding the touch panel 300 to the upper polarizing plate 200, the laminating process is performed in a direction corresponding to the polarizing direction of the lower plate. Modes of the LCD device are classified into Normally White mode-NW mode and Normally Black Mode-NB mode, or Ordinary mode-O mode and Extraordinary mode-E mode, so that the laminating process is performed such that an absorbing axis of the upper polarizing plate 200 corresponds to an adsorbing axis of the lower polarizing plate. The passivation layers 201 and 203 can be formed of Tri-Acetyl Cellulose (TAC), for example, at upper and lower sides of the optical layer 202. The optical layer 202 can be formed of Polyvinyl Alcohol (PVA), for example.

In the LCD device according to the related art, a hard coating layer is formed on the uppermost layer of the upper polarizing plate. However, in the touch panel integrated with the LCD device according to the present invention, the touch panel is positioned on a planar surface of the uppermost layer of the LCD device. Thus, the expense of forming the hard coating layer on the upper polarizing plate is not required.

As mentioned above, the touch panel integrated with the LCD device according to the present invention has the following advantages. In the touch panel integrated with the LCD device according to the present invention, the upper polarizing plate of the LCD panel is formed of a first passivation layer, an optical layer, and a second passivation layer, in which an additional hard coating layer is not required. Accordingly, the contact surface of the upper polarizing plate and the touch panel is planar so that it is possible to write comfortably, which helps to increase the life span of the touch panel. Since, the anti-glare process or the hard coating layer of the upper polarizing plate is omitted, manufacturing costs are decreased.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A touch panel integrated with an LCD device comprising:
a lower polarizing plate;
an LCD panel having a lower substrate on the lower polarizing plate, an upper substrate on the lower substrate, and a liquid crystal layer between the upper and lower substrates;
an upper polarizing plate on the upper substrate having a planar surface; and
a touch panel bonded directly to the planar surface of the upper polarizing plate.

2. The touch panel of claim 1, wherein the upper polarizing plate is formed by sequentially depositing a first passivation layer, an optical layer on the first passivation layer, and a second passivation layer on the optical layer.

3. The touch panel of claim 2, wherein the first and second passivation layers are formed of Tri-Acetyl-Cellulose (TAC) films.

4. The touch panel of claim 2, wherein the optical layer is formed of a Polyvinyl Alcohol (PVA) film.

5. The touch panel of claim 4, wherein the PVA film is formed with an adhesive alignment method with a bicolor pigment such as a bicolor dye or an iodine material.

6. The touch panel of claim 1, wherein the uppermost layer of the upper polarizing plate is a passivation layer.

7. The touch panel of claim 6, wherein the passivation layer is formed to protect an upper surface of the optical layer that polarizes light.

8. The touch panel of claim 1, wherein an adhesive is formed at least partially about the periphery of at least one of the touch panel and the upper polarizing plate.

9. A touch panel integrated with an LCD device comprising:
an LCD panel having a polarizing plate including first passivation layer, an optical layer on the first passivation layer, and a second passivation layer on the optical layer; and
a touch panel bonded directly to the second passivation layer of the polarizing plate.

10. The touch panel of claim 9, wherein surfaces of the second passivation layer and the touch panel along where the touch panel bonds directly to the second passivation layer are planar.

11. The touch panel of claim 9, wherein the first and second passivation layers are formed of Tri-Acetyl-Cellulose (TAC) films.

12. The touch panel of claim 9, wherein the optical layer is formed of a Polyvinyl Alcohol (PVA) film.

13. The touch panel of claim 12, wherein the PVA film is formed in an adhesive alignment method with one of a bicolor dye or an iodine material.

14. The touch panel of claim 9, wherein an adhesive is formed at least partially about the periphery of at least one of the touch panel and the second passivation layer.
